(19) United States
(12) Patent Application Publication
(10) Pub. No.: US 2005/0076329 A1
(43) Pub. Date: Apr. 7, 2005

(54) Method and apparatus for supporting configuration of a web application in a web presentation architecture

(76) Inventors: Christina Hsu, Mountain View, CA (US); Sankar Ram Sundaresan, San Jose, CA (US); Jeff A. Parks, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/677,004

(22) Filed: Oct. 1, 2003

(51) Int. Cl. G06F 9/44

(52) U.S. Cl. 717/105

(57) ABSTRACT

A system and method for creating web applications is disclosed. The system comprises a controller generator that is adapted to provide a web application with a controller that receives a request for data from a user and responds to the request by sending information to the user. The system also comprises a configurator generator that is adapted to provide a configurator that loads configuration information for use by the controller from a configuration file and stores the configuration information for subsequent access.

### BACKGROUND OF THE RELATED ART

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Web applications are increasingly complex programs that, in some cases, process enormous amounts of information for hundreds or even thousands of users at a time. A user may initiate a web transaction with a web application by sending information to the web application via a browser or the like. The web application may access data resources or otherwise obtain information from a variety of sources in response to a user request.

Performance of web applications may be degraded if data required for a transaction must be accessed on an as-needed basis and stored in memory rather than being stored in advance. This is particularly true if a web application is complex and manages large amounts of data.

### BRIEF DESCRIPTION OF THE DRAWINGS

Advantages of one or more disclosed embodiments may become apparent upon reading the following detailed description and upon reference to the drawings in which:

FIG. 1 is a block diagram that illustrates a model-view-controller (“MVC”) application architecture, which may be created using embodiments of the present invention;

FIG. 2 is a block diagram that illustrates a web presentation architecture in accordance with embodiments of the present invention;

FIG. 3 is a block diagram that illustrates the operation of configurator functionality in a web application program created using a web presentation architecture in accordance with embodiments of the present invention; and

FIG. 4 is an object diagram of an architecture for object classes associated with configurator functionality in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

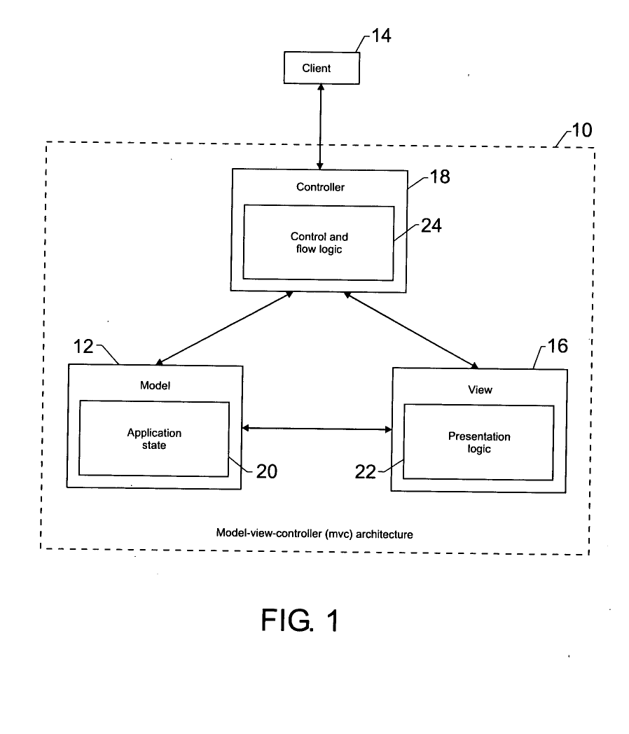

FIG. 1 is a block diagram that illustrates a model-view-controller (“MVC”) application architecture, which may be created using embodiments of the present invention. As illustrated, the MVC architecture 10 separates the application object or model 12 from a view 16, which is responsible for receiving input and presenting output to a client 14. In a web application context, the client 14 may comprise a browser. The model object and the view are also separated from the control functions of the application, which are represented in FIG. 1 as a controller 18. In general, the model 12 comprises an application state 20, the view 16 comprises presentation logic 22, and the controller 18 comprises control and flow logic 24. By separating these three MVC objects 12, 16, and 18 with abstract boundaries, the MVC architecture 10 provides flexibility, organization, performance, efficiency, and reuse of data, presentation styles, and logic.

The WPA 100 may be configured with a variety of object-oriented programming languages, such as Java by Sun Microsystems, Inc., Santa Clara, Calif. An object is generally an item that can be individually selected and manipulated. In object-oriented programming, an object may comprise a self-contained entity having data and procedures to manipulate the data. For example, a Java-based system may utilize a variety of JavaBeans, servlets, Java Server Pages (“JSPs”), and so forth. JavaBeans are independent, reusable software modules. In general, JavaBeans support introspection (a builder tool can analyze how a JavaBean works), customization (developers can customize the appearance and behavior of a JavaBean), events (JavaBeans can communicate), properties (developers can customize and program with JavaBeans), and persistence (customized JavaBeans can be stored and reused). JSPs provide dynamic scripting capabilities that work in tandem with hypertext markup language (“HTML”) code, separating the page logic from the static elements. According to certain embodiments, the WPA 100 may be designed according to the Java 2 Platform Enterprise Edition (J2EE), which is a platform-independent, Java-centric environment for developing, building and deploying multi-tiered Web-based enterprise applications online.

The model 12 comprises a definitional framework representing the application state 20. For example, in a web-based application, the model 12 may comprise a JavaBean object or other suitable means for representing the application state 20. Regardless of the application or type of object, an exemplary model 12 may comprise specific data and expertise or ability (methods) to get and set the data (by the caller). The model 12 generally focuses on the intrinsic nature of the data and expertise, rather than the extrinsic views and extrinsic actions or business logic to manipulate the data. However, depending on the particular application, the model 12 may or may not contain the business logic along with the application state. For example, a large application having an application tier may place the business logic in the application tier rather than the model objects 12 of the web application, while a small application may simply place the business logic in the model objects 12 of the web application.

As noted above, the view and controller objects 16 and 18 separately address these extrinsic views and actions or business logic. For example, the model 12 may represent data relating to a person (e.g., an address, a birth date, phone number, etc.), yet the model 12 is independent of extrinsic formats (e.g., a date format) for displaying the personal data or extrinsic actions for manipulating the personal data (e.g., changing the address or phone number). Similarly, the model 12 may represent data and expertise to track time (e.g., a clock), yet the model 12 is independent of specific formats for viewing the clock (e.g., analog or digital clock) or specific actions for manipulating the clock (e.g., setting a different time zone). These extrinsic formats and extrinsic actions are simply not relevant to the intrinsic behavior of the model clock object. One slight exception relates to graphical model objects, which inherently represent visually perceptible data. If the model 12 represents a particular graphical object, then the model 12 may include the capability of drawing itself while remaining independent of extrinsic formats for displaying the graphical object or extrinsic actions for creating or manipulating the graphical object.

The view 16 generally manages the visually perceptible properties and display of data, which may be static or dynamic data derived in whole or in part from one or more model objects 12. As noted above, the presentation logic 22 functions to obtain data from the model 12, format the data for the particular application, and display the formatted data to the client 14. For example, in a web-based application, the view 16 may comprise a Java Server Page (JSP page) or an HTML page having presentation logic 22 to obtain, organize, format, and display static and/or dynamic data. Standard or custom action tags (e.g., jsp:useJavaBean) may function to retrieve data dynamically from one or more model objects 12 and insert model data within the JSP pages. In this manner, the MVC architecture 10 may facilitate multiple different views 16 of the same data and/or different combinations of data stored by one or more model objects 12.

The controller 18 functions as an intermediary between the client 14 and the model object 12 and view 16 of the application. For example, the controller 18 can manage access by the view 16 to the model 12 and, also, manage notifications and changes of data among objects of the view 16 and objects of the model 12. The control and flow logic 24 of the controller 18 also may be subdivided into model-controllers and view-controllers to address and respond to various control issues of the model 12 and the view 16, respectively. Accordingly, the model-controllers manage the models 12 and communicate with view-controllers, while the view-controllers manage the views 16 and communicate with the model-controllers. Subdivided or not, the controllers 18 ensure communication and consistency between the model 12, the view 16 and the client 14.

In operation, the control and flow logic 24 of the controller 18 generally receives requests from the client 14, interprets the client requests, identifies the appropriate logic function or action for the client requests, and delegates responsibility of the logic function or action. Requests may be received from the client via a number of protocols, such as Hyper Text Transfer Protocol (“HTTP”) or HTTP with Secure Sockets Layer (“HTTPS”). Depending on the particular scenario, the appropriate logic function or action of the controller 18 may include direct or indirect interaction with the view 16 and/or one or more model objects 12. For example, if the appropriate action involves alteration of extrinsic properties of data (e.g. reformatting data in the view 16), then the controller 18 may directly interact with the view 16 without the model 12. Alternatively, if the appropriate action involves alteration of intrinsic properties of data (e.g., values of data in the model 12), then the controller 18 may act to update the corresponding data in the model 12 and display the data in the view 16.

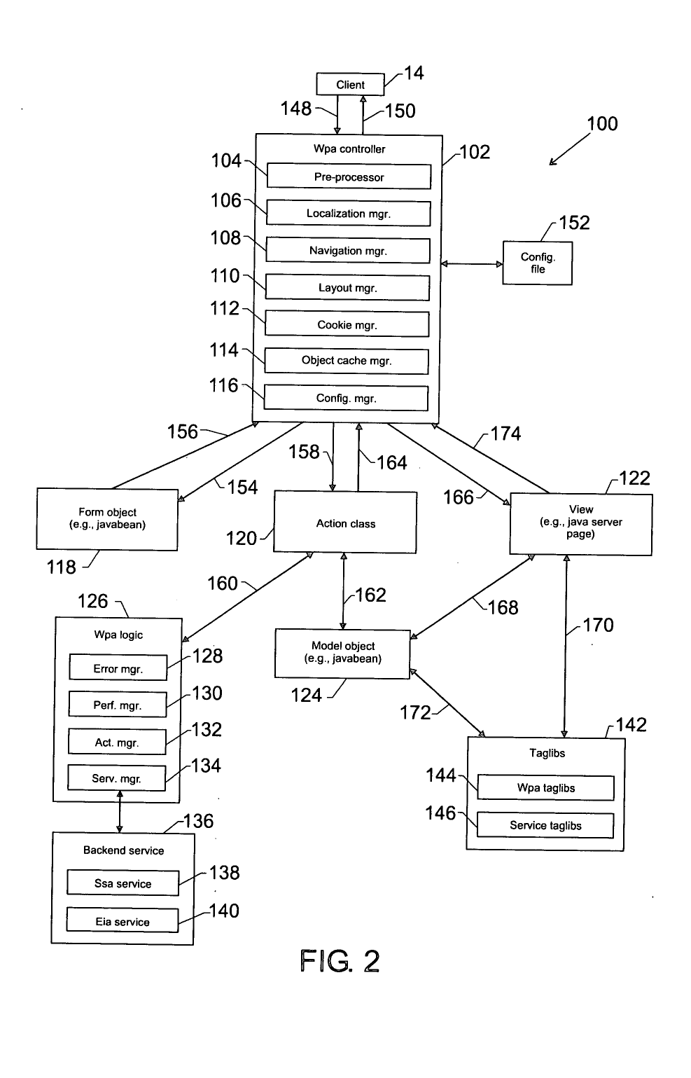

FIG. 2 is a block diagram illustrating an exemplary web presentation architecture (“WPA”) 100 in accordance with certain embodiments of the present invention. The illustrated WPA 100, which may be adapted to execute on a processor-based device such as a computer system or the like, has certain core features of the MVC computing strategy, and various additional features and enhancements to improve its architectural operation and performance. For example, the illustrated WPA 100 separates the model, the view, and the controller as with the traditional MVC architecture, yet the WPA 100 provides additional functionality to promote modularity, flexibility, and efficiency.

As illustrated, the WPA 100 comprises a WPA controller 102 having a preprocessor 104, a localization manager 106, the navigation manager 108, a layout manager 110, a cookie manager 112, and object cache manager 114, and a configuration manager 116. The WPA controller 102 functions as an intermediary between the client 14, form objects 118, action classes 120, and views 122. In turn, the action classes 120 act as intermediaries for creating/manipulating model objects 124 and executing WPA logic 126, such as an error manager 128, a performance manager 130, and activity manager 132, and a backend service manager 134. As described below, the backend service manager 134 functions to interface backend services 136. Once created, the model objects 124 can supply data to the view 122, which can also call various tag libraries 142 such as WPA tag libraries 144 and service tag libraries 146.

In operation, the client 14 sends a request 148 to the WPA 100 for processing and transmission of a suitable response 150 back to the client 14. For example, the request 148 may comprise a data query, data entry, data modification, page navigation, or any other desired transaction. As illustrated, the WPA 100 intakes the request 148 at the WPA controller 102, which is responsible for various control and flow logic among the various model-view-controller divisions of the WPA 100. For example, the WPA controller 102 can be implemented as a Servlet, such as a HyperText Transfer Protocol (“HTTP”) Servlet, which extends the ActionServlet class of Struts (an application framework promulgated by the Jakarta Project of the Apache Software Foundation). As illustrated, the WPA controller 102 invokes a configuration resource file 152, which provides mapping information for form classes, action classes, and other objects. Based on the particular request 148, the WPA controller 102 locates the appropriate action class and, also, the appropriate form class if the request 148 contains form data (e.g., client data input). For example, the WPA controller 102 may lookup a desired WPA Action Form and/or WPA Action Class, which function as interfaces to WPA Form Objects and WPA Action Objects.

If the client entered data, then the WPA controller 102 creates and populates the appropriate form object 118 as indicated by arrow 154. The form object 118 may comprise any suitable data objects type, such as a JavaBean, which functions to store the client entered data transmitted via the request 148. The WPA controller 102 then regains control as indicated by arrow 156.

If the client did not enter data, or upon creation and population of the appropriate form object 118, then the WPA controller 102 invokes the action class 120 to execute various logic suitable to the request 148 as indicated by arrow 158. For example, the action class 120 may call and execute various business logic or WPA logic 126, as indicated by arrow 160 and discussed in further detail below. The action class 120 then creates or interacts with the model object 124 as indicated by arrow 162. The model object 124 may comprise any suitable data object type, such as a JavaBean, which functions to maintain the application state of certain data. One example of the model object 124 is a shopping cart JavaBean, which stores various user data and e-commerce items selected by the client. However, a wide variety of model objects 124 are within the scope of the WPA 100. After executing the desired logic, the action class 120 forwards control back to the WPA controller 102 as indicated by arrow 164, which may be referred to as an “action forward.” This action forward 164 generally involves transmitting the path or location of the server-side page, e.g., the JSP.

As indicated by arrow 166, the WPA controller 12 then invokes the foregoing server-side page as the view 122. Accordingly, the view 122 interprets its links or tags to retrieve data from the model object 124 as indicated by arrow 168. Although a single model object 124 is illustrated, the view 122 may retrieve data from a wide variety of model objects. In addition, the view 122 interprets any special logic links or tags to invoke tag libraries 142 as indicated by arrow 170. For example, the WPA tag libraries 144 and the service tag libraries 146 can include various custom or standard logic tag libraries, such as <html>, <logic>, <template> developed as part of the Apache Jakarta Project or the like. Accordingly, the tag libraries 142 further separate the logic from the content of the view 122, thereby facilitating flexibility and modularity. In certain cases, the tag libraries 142 also may interact with the model object 124 as indicated by arrow 172. For example, a special tag may execute logic to retrieve data from the model object 124 and manipulate the retrieved data for use by the view 122. After interacting with the model object 124 and the appropriate tag libraries 142, the WPA 100 executes the view 122 (e.g., JSP) to create a client-side page for the client 14 as indicated by arrow 174. For example, the client-side page may comprise an extended markup language (“XML”) or HTML formatted page, which the WPA controller 102 returns to the client 14 via the response 150.

As discussed above, the WPA 100 comprises a variety of unique logic and functional components, such as control components 104 through 116 and logic 128 through 134, to enhance the performance of the overall architecture and specific features 100. These components and logic generally operate on the server-side of the WPA 100, yet there are certain performance improvements that may be apparent on the client-side. These various components, while illustrated as subcomponents of the controller 102 or types of logic 126, may be standalone or integrated with various other portions of the WPA 100. Accordingly, the illustrated organization of these components is simply one exemplary embodiment of the WPA 100, while other organizational embodiments are within the scope of the present technique.

Turning to the subcomponents of the WPA controller 102, the preprocessor 104 provides preprocessing of requests by configuring portal specific functions to execute for each incoming request registered to the specific portal. The preprocessor 104 identifies the appropriate portal specific functions according to a preset mapping, e.g., a portal-to-function mapping in the configuration file 152. Upon completion, the preprocessor 104 can redirect to a remote Uniform Resource Identifier (URI), forward to a local URI, or return and continue with the normal processing of the request 148 by the WPA controller 102. One example of such a preprocessing function is a locale, which is generally comprised of language preferences, location, and so forth. The preprocessor 104 can preprocess local logic corresponding to a particular portal, thereby presetting language preferences for subsequent pages in a particular application.

The locale information is also used by the localization manager 106, which functions to render localized versions of entire static pages rather than breaking up the static page into many message strings or keys. Instead of using a single page for all languages and obtaining localized strings from other sources at run time, the localization manager 106 simply looks up a localized page according to a locale identifier according to a preset mapping, e.g., a locale-to-localized page mapping in the configuration file 152. For example, the capability to render static localized pages in the localization manager 106 is particular useful for static information, such as voluminous help pages.

The navigation manager 108 generally functions to save a users intended destination and subsequently recall that information to redirect the user back to the intended destination. For example, if the user intends to navigate from point A to point B and point B queries for certain logic at point C (e.g., a user login and password), then the navigation manager 108 saves the address of point B, proceeds to the requested logic at point C, and subsequently redirects the user back to point B.

The layout manager 110 enables a portal to separate the context logic functioning to render the common context from the content logic functioning to render the content portion of the page. The common context (e.g., C-Frame) may include a header, a bottom portion or footer, and a side portion or side bar, which collectively provides the common look and feel and navigational context of the page.

The cookie manager 112 functions to handle multiple cookie requests and to set the cookie value based on the most recent cookie request before committing a response. For example, in scenarios where multiple action classes attempt to set a particular cookie value, the cookie manager 112 caches the various cookie requests and defers setting the cookie value until response time. In this manner, the cookie manager 112 ensures that different action classes do not erase cookie values set by one another and, also, that only one cookie can exist with a particular name, domain, and path.

The object cache manager 114 enables applications to create customized in-memory cache for storing objects having data originating from backend data stores, such as databases or service based frameworks (e.g., Web Services Description Language “WSDL”). The in-memory cache may be customized according to a variety of criteria, such as cache size, cache scope, cache replacement policy, and time to expire cache objects. In operation, the object cache manager 114 improves performance by reducing processing time associated with the data from the backend data stores. Instead of retrieving the data from the backend data stores for each individual request 148, the object cache manager 114 caches the retrieved data for subsequent use in processing later requests.

The configuration manager 116 functions to oversee the loading of frequently used information, such as an error code table, into memory at startup time of a particular web application. The configuration manager 116 may retain this information in memory for the duration of an application server session, thereby improving performance by eliminating the need to load the information each time the server receives a request.

Turning to the WPA logic 126, the error handler or manager 128 functions to track or chain errors occurring in series, catalog error messages based on error codes, and display error messages using an error catalog. The error catalog of the error manager 128 may enable the use of generic error pages, which the error manager 128 populates with the appropriate error message at run time according to the error catalog.

The WPA logic function 126 may comprise performance and activity managers 130 and 132, which may facilitate tracking and logging of information associated with a particular transaction or request. The error manager 128 may also be adapted to participate in tracking and logging operations as well.

The service manager 134 of the WPA logic 126 functions as an interface between the WPA 100 and various backend services 136. In operation, the service manager 134 communicates with the desired backend service 136 according to the client request 148, parses a response from the backend service 136 to obtain the appropriate data, and pass it to the appropriate object of WPA 100.

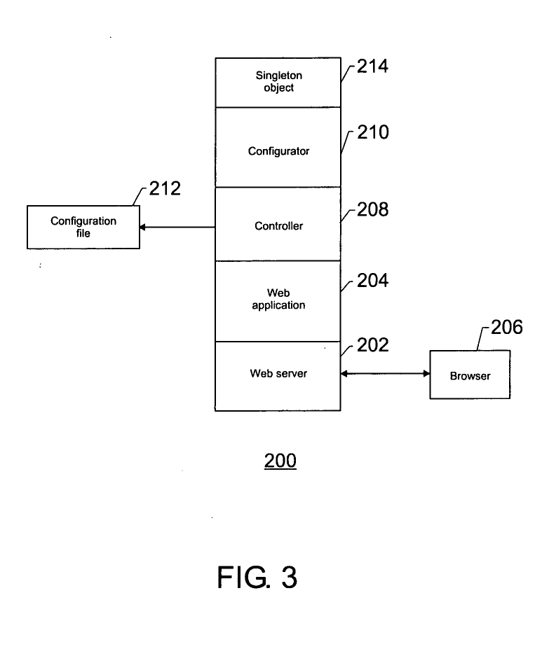

The following discussion relates to an implementation of an initial configuration capability for web applications constructed according to a web presentation architecture in accordance with embodiments of the present invention. Web applications typically require access to a number of data objects during their normal operation. The configurator functionality of the present invention operates to load needed configuration data into memory at startup time so that it may be used by HTTP requests that come into the server later. One example of such data that may be initially loaded in anticipation of being needed at a later time is an error code table. Another example is data that may be needed to facilitate logging operations. Typically, the values of such data are static and do not change after the web application has started. The operation of configurator functionality in an exemplary web application is explained with reference to FIG. 3.

FIG. 3 is a block diagram that illustrates the operation of configurator functionality in a web application program created using a web presentation architecture in accordance with embodiments of the present invention. The diagram is generally referred to by the reference numeral 200.

A web server 202 hosts a web application 204, which may be accessed by using a browser 206 or the like. The web application 204 embodies a controller 208, which may be created according to the WPA controller architecture 102 (FIG. 2). Also included in the web application 204 is a configurator 210, which is constructed according to the configuration manager architecture 116 (FIG. 2). Although only a single configurator 210 is illustrated in FIG. 3, multiple configurators may be implemented and each may be responsible for loading configuration information related to a specific functionality. Those of ordinary skill in the art will appreciate that the configurator 210 (or configurators) may comprise one or more operational modules and may be separate from or integral with the web application 204. Additionally, the controller 208 may be integral with the web application 204 or it may function as a separate operational module.

The configurator 210 may have the purpose of providing a centralized way of loading startup objects that may be required during the operation of the web application 204. For example, the configurator 210 may be adapted to load data from the configuration file or files 212 upon execution of the init( ) method of the controller 208. Data loaded by the configurator 210 may be stored in one or more configuration files 212, which may comprise one or more text properties configuration files or the like. After data from the configuration file or files 212 is loaded by the configurator 210, the data may be stored as a singleton object 214. A singleton object is an object that exists in memory such that only one of that type of object exists at any time in memory. Once created, a singleton object is not destroyed after use, like most objects, but is kept in memory until accessed again.

The configurator 210 may comprise one or more classes of objects. Each configurator class may implement a configurator interface and may override the configure(ActionServlet servlet) method. In order to avoid undesirable dependencies, the servlet must be a parameter. The servlet may be used to obtain the servletContext so that properties files such as the configuration file or files 212 may be located and read. Once properties files are located and read, the information may be stored in a singleton object such as the singleton object 214, which may be referred to as a “mapper.” The singleton object 214 may then be used by developers of web applications to access the information gathered from the properties files. If a configurator class does not need to access a property file, the servlet parameter is not used.

The configurator 210 may comprise a plurality of classes, which may be referred to as “actors.” Those actors may include the following:
WPAController—the controller (for example, the controller 205 (FIG. 3)).
WPAConfiguratorController—the class that creates the configurator objects.
Configurators—startup classes loaded by the configuration manager architecture 116 (FIG. 1) in the init( ) method of the WPAController, which may look for and read properties files. The configuration manager architecture 116 (FIG. 2) may be passed a list of configurators to create and execute.
Mappers—singleton objects used by the configurators to store the properties loaded from the properties files.
Properties Files—the data file containing information needed by programmers. These files, which may correspond to the configuration file or files 212, are located and read by configurators, then the information is loaded into mappers.
Programmer—a user of the singleton mapper objects to access information loaded from the properties files.

The following use case describes a typical course of events for a situation in which a configurator does not need to load properties files:
1. The WPAController starts as a result of its container being started.
2. In the WPAController init( ) method, an instance of WPAConfiguratorController is created, with the ActionServlet passed in as a parameter to the constructor. WPAConfiguratorController.startup( ) is then called, and is passed a string of configurator class names delimited by a predetermined special character (for example, a “|” character). An example of a string of configurator class names follows:
   “com.samplePath.SamplePropertiesConfigurator|com.sampl ePath.SampleErrorCodeConfigurator.”
3. WPAConfigurator parses the configurator string, creates new instances of each configurator, then calls each configurator's configure( ) method, passing it the ActionServlet.
4. The configurator's configure method executes without using the servlet object. A mapper object is not needed.

The following use case describes a typical course of events for a situation in which a configurator class must load a properties file:
1. The WPAController starts as a result of its container being started.
2. In the WPAController init( ) method, an instance of WPAConfiguratorController is created, with the ActionServlet passed in as a parameter to the constructor. WPAConfiguratorController.startup( ) is then called, and is passed a string of configurator class names delimited by a predetermined special character (for example, a “|” character). An example of a string of configurator class names follows:
   “com.samplePath.SamplePropertiesConfigurator|com.sampl ePath.SampleErrorCodeConfigurator.”
3. WPAConfigurator parses the configurator string, creates new instances of each configurator, then calls each configurator's configure( ) method, passing it the ActionServlet.
4. The configure( ) method uses the servlet to get a ServletContext object and locates the properties files of all the services.
5. Each property file is loaded into the configurator's specific mapper object by loading that mapper's Properties object.

6. A programmer can access the needed information by obtaining an instance of the particular mapper object and using its getInstance( ) method. This works because the mapper is a singleton object.

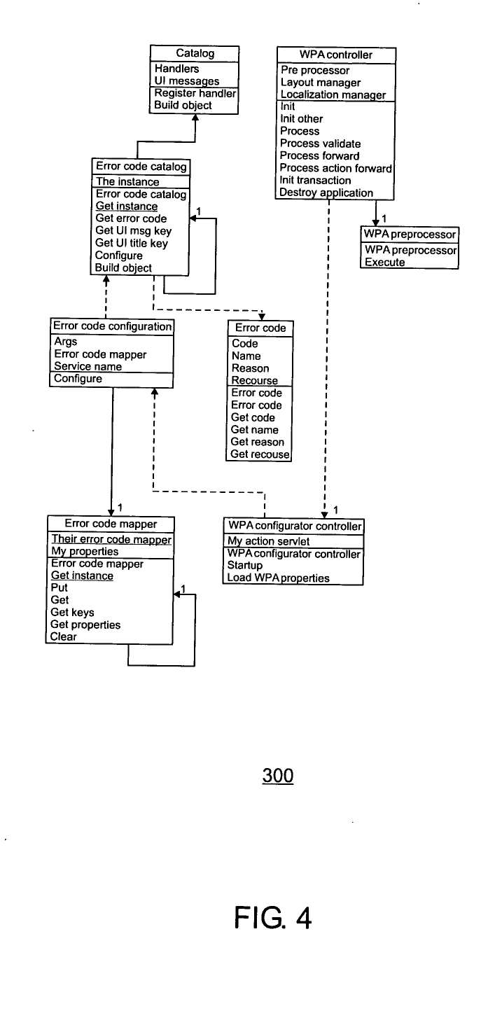

FIG. 4 is an object diagram of an architecture for object classes associated with configurator functionality in accordance with embodiments of the present invention. The diagram is generally referred to by the reference numeral 300. For simplicity, the object model contains only one configurator class.

The Configurator represents an interface that configurator classes may implement. An example of a method that may be associated with the Configurator class follows:
public void configure(ActionServlet servlet) throws StartupException—The ActionServlet parameter will enable subclasses to locate and open properties files using the ServletContext object obtained from the servlet.

The startup method of the WPAConfiguratorController object takes in a string containing the configurator class names delimited with a predetermined special character (for example, a “|” character). It then parses the string, creates a new instance of each configurator, and calls each configurator's configure( ) method. Each configure( ) method takes in an ActionServlet as a parameter. The following methods may be implemented with respect to the WPAConfiguratorController object:
public WPAConfiguratorController(ActionServlet servlet)—This is the constructor.
public String startup(String configurators) throws StartupException—This oversees parsing the configurator string, creating the classes, and calling their configure( ) methods.

Each Configurator subclass may implement the configure(ActionServlet) method defined in the Configurator interface. The Configurators that need to read properties files will use the ActionServlet to locate the correct properties files. Configurators that do not need to read properties files are not required to utilize the servlet parameter. A public void configure(ActionServlet servlet) method may be associated with the Configurator subclasses.

The following list represents exemplary Configurators that may be called upon initialization of an associated controller:
ErrorCodeConfigurator—Loads all errorcode.properties files and loads entries into an error catalog for use with WPA exceptions.
PersistCommandConfigurator—Loads persistCommand.properties files for use during logging.
LogConfigurator—configures logging mechanism, setting it up for the web presentation architecture and for services.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A system for creating web applications, the system comprising:
a controller generator that is adapted to provide a web application with a controller that receives a request for data from a user and responds to the request by sending information to the user; and
a configurator generator that is adapted to provide a configurator that loads configuration information for use by the controller from a configuration file and stores the configuration information for subsequent access.

2. The system set forth in claim 1, wherein the configuration file is a text properties configuration file.

3. The system set forth in claim 1, wherein the configurator is adapted to store the configuration information as a singleton object.

4. The system set forth in claim 1, wherein the configuration information comprises error handling information.

5. The system set forth in claim 1, wherein the configuration information comprises log processing information.

6. The system set forth in claim 1, wherein the configuration information comprises data that is specific to each of a plurality of portals.

7. The system set forth in claim 1, wherein the configurator is adapted to read the configuration information upon initialization of the controller.

8. A method of creating web applications, the method comprising:
creating, with a processor-based device, a controller that receives a request for data from a user and responds to the request by sending information to the user; and
providing a configurator that loads configuration information for use by the controller from a configuration file and stores the configuration information for subsequent access.

9. The method set forth in claim 8, comprising defining the configuration file to be a text properties configuration file.

10. The method set forth in claim 8, comprising adapting the configurator to store the configuration information as a singleton object.

11. The method set forth in claim 8, comprising defining the configuration information to comprise error handling information.

12. The method set forth in claim 8, comprising defining the configuration information to comprise log processing information.

13. The method set forth in claim 8, comprising defining the configuration information to comprise data that is specific to each of a plurality of portals.

14. The method set forth in claim 8, comprising adapting the configurator to read the configuration information upon initialization of the controller.

15. A system for creating web applications, the system comprising:
means for creating a controller that is adapted to receive a request for data from a user and respond to the request; and
means for creating a configurator that loads configuration information for use by the controller from a configuration file and stores the configuration information for subsequent access.

16. The system set forth in claim 15, wherein the configuration file is a text properties configuration file.

17. The system set forth in claim 15, wherein the configurator is adapted to store the configuration information as a singleton object.

18. The system set forth in claim 15, wherein the configuration information comprises error handling information.

19. The system set forth in claim 15, wherein the configuration information comprises log processing information.

20. The system set forth in claim 15, wherein the configuration information comprises data that is specific to each of a plurality of portals.

21. The system set forth in claim 15, wherein the configurator is adapted to read the configuration information upon initialization of the controller.

22. A machine readable medium, comprising:
a controller generator stored on the machine readable medium, the controller generator being adapted to provide a web application with a controller that receives a request for data from a user and responds to the request by sending information to the user; and
a configurator generator stored on the machine readable medium, the configurator generator being adapted to provide a configurator that loads configuration information for use by the controller from a configuration file and stores the configuration information for subsequent access.

23. The machine readable medium set forth in claim 22, wherein the configurator generator is adapted to produce a configurator that stores the configuration information as a singleton object.

24. The machine readable medium set forth in claim 22, wherein the configurator generator is adapted to produce a configurator that reads the configuration information upon initialization of the controller.
